(19) United States
(12) Patent Application Publication
(10) Pub. No.: US 2008/0088195 A1
(43) Pub. Date: Apr. 17, 2008

(54) OUTSIDE ROTOR ELECTRIC MACHINE

(76) Inventors: Kevin A. DOOLEY, Mississauga (CA); Joseph Brand, Mississauga (CA); Michael Dowhan, Milton (CA)

Correspondence Address: OGILVY RENAULT LLP (PWC), 1981 MCGILL COLLEGE AVENUE, SUITE 1600, MONTREAL, QC, H3A 2Y3, US

(21) Appl. No.: 11/549,764

(22) Filed: Oct. 16, 2006

(51) Int. Cl. H02K 7/00; H02K 21/12

(52) U.S. Cl. 310/156.26; 310/156.12; 310/67 R

(57) ABSTRACT

An electric machine including an outside rotor having a first member providing a magnetic path between adjacent ones of a circumferential array of magnets, and a second member surrounding and inducing a compression load in the first member.

### TECHNICAL FIELD

The invention relates generally to electric machines such as generators and motors and, more particularly, to an improved outside rotor electric machine.

### BACKGROUND OF THE ART

Some inside rotor electric machines, i.e. machines having a rotor received inside a stator, have a rotor with magnets retained around a shaft and surrounded by a non-magnetic ring. Generally, the ring compresses the magnets and the rotor shaft to pre-stress the rotor such as to prevent the magnets from being separated from the shaft at high rotation speeds. However, such a ring defines a layer of non-magnetic material between the magnets and the stator, thus interfering with the magnetic flux by effectively increasing the air gap. As such, thicker magnets must generally be used to obtain a given magnetic flux, which results in a generally heavier rotor, thus a lower maximum rotation speed and/or a lower power density.

Some outside rotor electric machines, i.e. machines having a rotor surrounding the stator, have a rotor with magnets retained within a magnetic ring which acts both as part of the magnetic circuit (also known as the back iron) and provides the necessary strength to resist the loads produced during use. Generally, the retaining ring is sized according to the necessary load carrying capability or hoop strength, and is significantly thicker that would otherwise be required to obtain the necessary magnetic capability, i.e. the hoop strength requirements substantially exceed the magnetic capability requirements. The use of a thicker ring for a given magnetic capability generally results in a heavier rotor, with consequent adverse effect on the rotor dynamics of the assembly thus a lower rotation speed and/or a lower power density.

Accordingly, improvements are desirable.

### SUMMARY OF THE INVENTION

It is therefore an object of this invention to provide an improved outside rotor for an electric machine.

In one aspect, the present invention provides an electric machine comprising an inner stator and a rotor surrounding the stator, the rotor including an array of circumferentially spaced apart magnets forming alternating poles and defining at least part of a circumferential inner surface adapted to extend adjacent the stator, a retaining ring surrounding and retaining the magnets, the retaining ring including a magnetic material and defining a magnetic path between adjacent ones of the magnets, and a containment ring surrounding the retaining ring, the containment ring being disposed outside of the magnetic path and having an interference fit with the retaining ring such as to produce a hoop compression stress in the retaining ring.

In another aspect, the present invention provides an electric machine comprising an inner stator and a rotor surrounding the stator, the rotor including an array of circumferentially spaced apart magnets forming alternating poles and defining at least part of a circumferential rotor surface adapted to extend adjacent the stator, first means for providing a magnetic path between adjacent ones of the magnets, and second means for surrounding and inducing a compression load in the first means to increase a load resistance of the first means during rotation of the rotor, the second means being disposed outside of the magnetic path.

In a further aspect, the present invention provides an outside rotor for an electric machine, the outside rotor comprising a circumferential array of spaced apart magnets forming alternating poles, the magnets defining at least part of an inner surface adapted to extend adjacent a stator, a retaining ring surrounding and retaining the magnets, the retaining ring including a magnetic material and defining a magnetic path between adjacent ones of the magnets, and a containment ring surrounding the retaining ring and producing a hoop compression stress in the retaining ring, the containment ring being remote from the magnetic path.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a transverse cross-sectional view of an outside rotor electric machine according to a particular aspect of the present invention;

FIG. 2 is an exploded perspective view of the machine of FIG. 1; and

FIG. 3 is a partial longitudinal cross-sectional view of the machine of FIG. 1.

### DETAILED DESCRIPTION OF THE PREFERRED EMBODIMENTS

Referring to the Figures, an electric machine according to a particular aspect of the present invention is generally shown at 10. The machine 10 has an “outside rotor” configuration, i.e. the machine comprises a rotor 12 which surrounds a stator 14.

The stator 14 is schematically shown in dotted lines, and may be any appropriate type of stator, including, but not limited to, a stator such as described in U.S. Pat. No. 6,965,183, issued Nov. 15, 2005 to Dooley, and which is incorporated herein by reference. A rotor air gap 24, radially defined between a circumferential inner surface 26 of the rotor 12 and an outer surface 28 of the stator 14, separates the rotor 12 and stator 14.

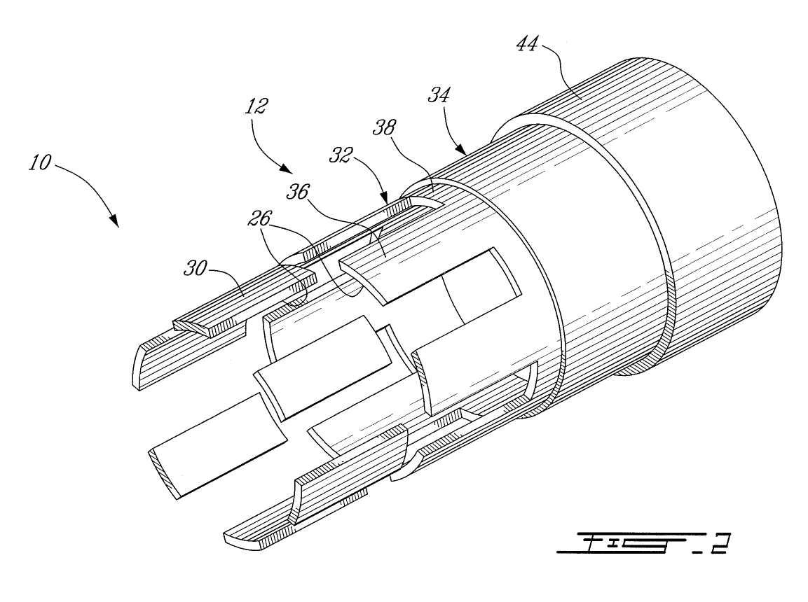

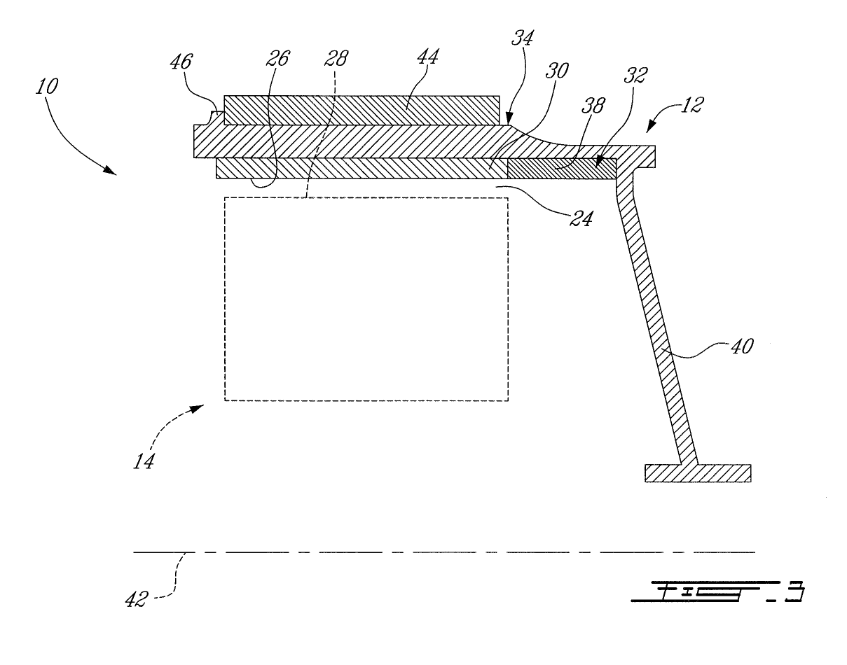

The rotor 12 generally comprises an array of circumferentially spaced apart magnets 30, which in the embodiment shown are permanent magnets, forming alternating poles. The magnets 30 are retained by a non-magnetic yoke 32 (in the present specification and claims, “non-magnetic” is also intended to include elements that have some, but negligible, magnetic capability relative to the magnets 30) and a retaining ring 34. The yoke 32 is generally crown-shaped, and includes an array of circumferentially spaced apart spacers 36 (not shown in FIG. 3) extending from a ring 38 (best seen in FIG. 2). Each magnet 30 is received between adjacent spacers 36, and abuts the adjacent spacers 36 and the ring 38, such that the magnets 30 and yoke 32 together define the cylindrical inner surface 26 of the rotor 12. In an alternate embodiment, the magnets 30 fill the inner circumference of the retaining ring 34 and as such the yoke 32 is omitted.

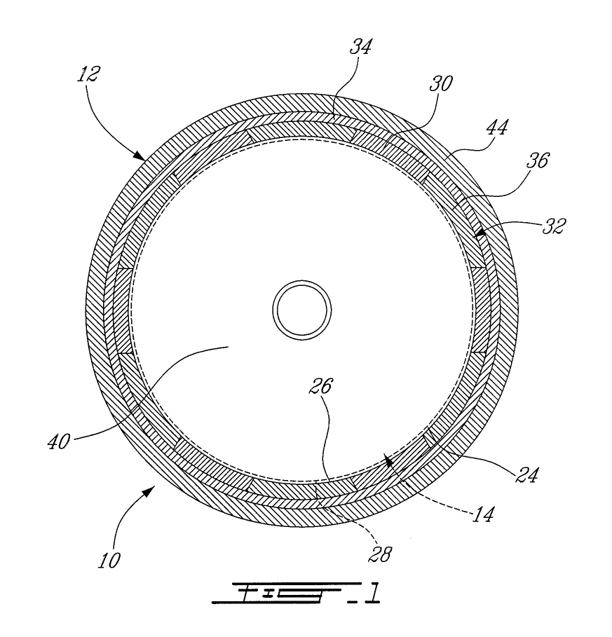

Referring to FIGS. 1 and 3, the retaining ring 34 surrounds the magnets 30 and yoke 32. The retaining ring 34 includes an attachment flange 40 extending radially inwardly and abutting the yoke ring 38 opposite of the magnets 30 to engage driving and/or drivable means such as a rotating shaft, which is represented in FIG. 3 by an axis of rotation 42. The attachment flange 40 is shown as a substantially conical flange, although other alternate flange geometries are also possible.

The retaining ring 34 also includes a magnetic material in order to complete a magnetic path between the magnets 30 with a minimum path length and as such maximize the magnetic flux density in the rotor air gap 24. The materials for the rotor 12 may be any deemed suitable by the designer, and may include in a particular embodiment samarium cobalt for the permanent magnets 30, maraging steel for the retaining ring 34, and aluminium, titanium or another appropriate lightweight non-magnetic material for the yoke 32.

The rotor 12 further comprises a containment ring 44 surrounding the retaining ring 34. In the embodiment shown, the retaining ring 34 includes a cylindrical shoulder 46 (see FIG. 3) against which the containment ring 44 is abutted. The containment ring 44 has an interference fit with the retaining ring 34, such as to produce a hoop compression load in the retaining ring 34 at initial assembly. In a particular embodiment, this is achieved by having the containment ring 44 shrink fitted around the retaining ring 34. Having this initial compressive stress in the retaining ring 34 has the effect of lowering the hoop stress in the rotor 12 during operation, through superposition of the compression pre-stressing load and the tensile operating load.

In a particular embodiment, the containment ring 44 is a sleeve comprising a lightweight, high stiffness, non-magnetic filament material wound around the retaining ring 34. Alternately, the containment ring 44 could also comprise an appropriate lightweight, high stiffness, magnetic material. Suitable material for the containment ring 44 include high strength composite materials, e.g. a fiber reinforced composite including carbon fiber such as reinforced carbon-carbon, carbon fibers in a matrix of polyimide, and other lightweight materials providing high strength and stiffness.

As is the case for conventional permanent magnet machines, the machine 10 may operate in a generator mode or a motor mode. When operated in a generator mode, an external torque source forces rotation of the flange 40 (and thus the rotor 12 and the magnets 30), and the interaction of the magnets 30 and the stator 14 causes a magnetic flux to loop therein. As the rotor 12 rotates, the magnetic flux in the stator 14 changes, and this changing flux results in an output current that can be used to power electrical devices, or be stored for later use. When operated in a motor mode, a voltage from an external source is applied to the stator 14 which causes current flow therein and results in a magnetic flux to be set up in a magnetic circuit therein. When current is supplied in an appropriate manner to stator 14, the rotor 12 can be made to rotate and thus produce usable torque.

The retaining ring 34 of the machine 10 is advantageously thinner and lighter when compared to the retaining ring of a similar rotor without a containment ring 44. As the pre-stressing of the retaining ring 34 by the containment ring 44 effectively decreases the hoop stress in the rotor 12 during use, a thinner and lighter retaining ring 34 can be used. For example, the retaining ring 34 can be sized according to the desired magnetic capability, while the containment ring 44 provides the necessary hoop strength to the rotor 12.

The containment ring 44 is made of a material having a stiffness at least equal to, and preferably greater than, the stiffness of the material of the retaining ring 34, for example a material having a Young's modulus approximately 2 times that of the material of the retaining ring 34. In a particular embodiment, the containment ring 44 is made of a material having a stiffness per unit of mass greater than that of the material of the retaining ring 34, such as to further reduce the overall weight of the rotor 12. A lighter rotor advantageously allows for rotation at higher maximum speed and/or acceptable dynamic characteristics, for an increase in power density of the machine 10.

In another particular embodiment, the containment ring 44 is made of a material having a stiffness per unit of volume greater than that of the material of the retaining ring 34, such as to reduce the overall size of the machine 10, thus allowing for a higher power density for a given machine size. Advantageously, the containment ring 44 can be made of a material having both a stiffness per unit of mass and a stiffness per unit of volume greater than those of the material of the retaining ring 34, such as is the case with a containment ring 44 made of reinforced carbon-carbon and a retaining ring 34 made of maraging steel, or any other suitable “soft” magnetic alloy material.

Since the containment ring 44 adds strength directly to the retaining ring 34, as opposed to a ring surrounding the magnets of an inside rotor for example, the rotor 12 is reinforced without introducing a material thickness between the magnets 30 and the stator 14. The absence of material between the magnets 30 and the stator 14 allows for a grater magnetic flux for a given magnet thickness, or, in other words, the use of thinner, lighter magnets for a given magnetic flux. Thinner magnets reduce the load created on the retaining ring 34 for a given speed of rotation, thus allowing for a greater speed of operation and thus a greater power capacity for a given size/weight of the machine 10. Accordingly, a higher power machine is obtained for a given machine weight.

Also, since the containment ring 44 provides the necessary strength to the rotor 12, the retaining ring 34 can be made a better, “soft” magnetic material, which may have lower strength, the containment ring 44 compensating for the lack of strength of the retaining ring 34. Such “soft” magnetic material include, for example, cobalt-iron alloys, silicon-iron alloys, and nickel-iron alloys.

In addition, the interference fit of the containment ring 44 around the retaining ring 34 results in friction which may advantageously act as a damper to free ring vibrations of the rotor 12.

The above description is meant to be exemplary only, and one skilled in the art will recognize that changes may be made to the embodiments described without department from the scope of the invention disclosed. For example, the containment ring can be used with outside rotors having a different geometries than the rotor described herein, including rotors having different types of magnets, e.g. electromagnets. Still other modifications which fall within the scope of the present invention will be apparent to those skilled in the art, in light of a review of this disclosure, and such modifications are intended to fall within the appended claims.

1. An electric machine comprising an inner stator and a rotor surrounding the stator, the rotor including an array of circumferentially spaced apart magnets forming alternating poles and defining at least part of a circumferential inner surface adapted to extend adjacent the stator, a retaining ring surrounding and retaining the magnets, the retaining ring including a magnetic material and defining a magnetic path between adjacent ones of the magnets, and a containment ring surrounding the retaining ring, the containment ring being disposed outside of the magnetic path and having an interference fit with the retaining ring such as to produce a hoop compression stress in the retaining ring.

2. The electric machine according to claim 1, wherein the containment ring is non-magnetic.

3. The electric machine according to claim 1, wherein the containment ring includes a fiber reinforced composite material.

4. The electric machine according to claim 3, wherein the fiber reinforced composite material includes reinforced carbon-carbon.

5. The electric machine according to claim 1, wherein the containment ring has a stiffness greater than that of the retaining ring.

6. The electric machine according to claim 5, wherein the stiffness, defined in lb/in. of the containment ring is approximately twice that of the retaining ring.

7. The electric machine according to claim 5, wherein the containment ring has a stiffness defined in lb/in per unit of mass greater than that of the retaining ring.

8. The electric machine according to claim 5, wherein the containment ring has a stiffness, defined in lb/in, per unit of volume greater than that of the retaining ring.

9. An electric machine comprising an inner stator and a rotor surrounding the stator, the rotor including an array of circumferentially spaced apart magnets forming alternating poles and defining at least part of a circumferential rotor surface adapted to extend adjacent the stator, first means for providing a magnetic pat between adjacent ones of the magnets, andsecond defined in lb/in, per unit of volume greater than that of the retaining ring.

9. An electric machine comprising an inner stator and a rotor surrounding the stator, the rotor including an array of circumferentially spaced apart magnets forming alternating poles and defining at least part of a circumferential rotor surface adapted to extend adjacent the stator, first means for providing a magnetic pat between adjacent ones of the magnets, and second means for surrounding and inducing a compression load in the first means to increase a load resistance of the first means during rotation of the rotor, the second means being disposed outside of the magnetic pat.

10. The electric machine according to claim 9, wherein the first means include a retaining ring surrounding the magnets.

11. The electric machine according to claim 9, wherein the second means include a containment ring having an interference fit with the first means.

12. The electric machine according to claim 9, wherein the second means is non-magnetic.

13. The electric machine according to claim 9, wherein the second means include a ring including a fiber reinforced composite material.

14. The electric machine according to claim 13, wherein the fiber reinforced composite material includes reinforced carbon-carbon.

15. The electric machine according to claim 9, wherein the second means has a stiffness greater than that of the first means.

16. The electric machine according to claim 15, wherein the second means has a stiffness, defined in lb/in, per unit of mass greater than that of the first means.

17. The electric machine according to claim 15, wherein the second means has a stiffness, defined in lb/b, per unit of volume greater than that of the first means.

18. An outside rotor for an electric machine, the outside rotor comprising:
a circumferential array of spaced apart magnets forming alternating poles, the magnets defining at least part of an inner surface adapted to extend adjacent a stator;
a retaining ring surrounding and, retaining the magnets, the retaining ring including a magnetic material and defining a magnetic path between adjacent ones of the magnets; and
a containment ring surrounding the retaining ring and producing a hoop compression stress in the retaining ring, the containment ring being remote from the magnetic path.

19. The rotor according to claim 18, wherein the containment ring includes a fiber reinforced composite material.

20. The rotor according to claim 18 wherein the containment ring has a stiffness greater than that of the retaining ring.
